(19) United States
(12) Patent Application Publication
(10) Pub. No.: US 2021/0402690 A1
(43) Pub. Date: Dec. 30, 2021

(54) VIBRATION COOLING OF BUILD MATERIAL

(71) Applicant: HEWLETT-PACKARD DEVELOPMENT COMPANY, L.P., Spring, TX (US)

(72) Inventors: Justin M. Roman, Vancouver, WA (US); Xavier Alonso Becerro, Sant Cugat del Valles (ES); Wojciech Jerzy Krasowski, Sant Cugat del Valles (ES); Neil Telfer, Sant Cugat del Valles (ES); Michael Duda, Vancouver, WA (US)

(21) Appl. No.: 16/607,550

(22) PCT Filed: Apr. 25, 2018
(86) PCT No.: PCT/US2018/029299

§ 371 Date: Oct. 23, 2019

(51) Int. Cl. B29C 64/245; B29C 64/255; B29C 64/165; B29C 64/35; B29C 64/364

(52) U.S. Cl. CPC B29C 64/245; B29C 64/255; B33Y 10/00; B29C 64/35; B29C 64/364; B29C 64/165

(57) ABSTRACT

There is disclosed a method of cooling a bed of build material 12, 14 generated by additive manufacture. A container 10 containing a bed of build material may be provided, the bed having a hot region relative to ambient temperature. The container may be vibrated to fluidize unfused build material 12 in the container so as to cause convection of the unfused build material to cool the hot region. There is also disclosed a method of cooling a bed of build material 12, 14 including vibration when the temperature of a hot region in the bed of build material is higher than an unpacking threshold. There is also disclosed a cooling apparatus for cooling a bed of build material by vibration.

### BACKGROUND

Additive manufacturing techniques may generate a three-dimensional object through the solidification of a build material. In examples of such techniques, build material may be supplied in a layer-wise manner and the solidification method may include heating the build material to cause melting in selected regions. In other techniques, chemical solidification methods may be used.

An additive manufacturing system may generate a bed of build material in which fused build material corresponds to generated objects and is surrounded by unfused material. In some particular examples, the bed of build material may be at elevated temperature relative to ambient conditions and cooled prior to unpacking the objects.

### BRIEF DESCRIPTION OF DRAWINGS

Examples will now be described, by way of non-limiting example, with reference to the accompanying drawings, in which:

FIGS. 1 and 2 are simplified cross-sectional schematics of an example container filled with a bed of build material at first and second stages of cooling by vibration;

FIGS. 3 and 4 are flowcharts of example methods of cooling build material;

FIGS. 5 and 6 are simplified cross-sectional schematics of an example cooling apparatus and container filled with a bed of build material; and

FIG. 7 is a flowchart of an example method of cooling build material.

### DETAILED DESCRIPTION

Additive manufacturing techniques may generate a three-dimensional object through the solidification of a build material. The build material may be powder-based and the properties of generated objects may depend on the type of build material and the type of solidification mechanism used. In a number of examples of such techniques including fusing techniques, build material is supplied in a layer-wise manner and the solidification method includes heating the layers of build material to cause melting in selected regions. In other techniques, chemical solidification methods may be used.

Additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

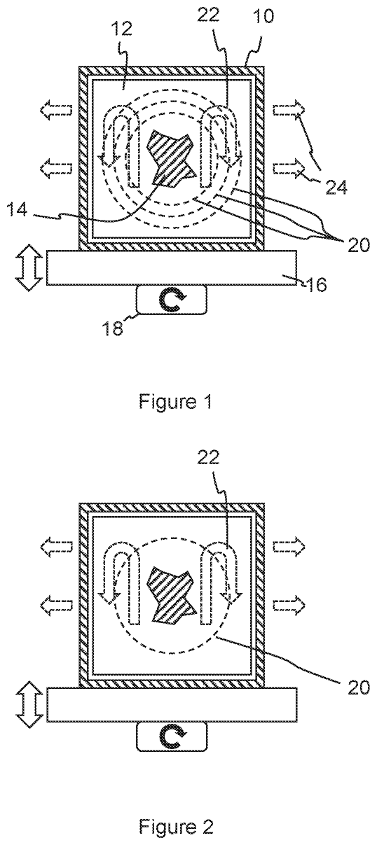

FIG. 1 shows a simplified example of a container 10 of build material 12, 14 generated by additive manufacture. For example, the bed of build material 12, 14 may be generated by an additive manufacture process in which build material is supplied in a layer-wise manner and selectively fused so that the bed comprises objects of fused build material 14 generated by the additive manufacture process, and unfused build material 12 that surrounds the objects of fused build material 14 in the bed.

The container 10 may be of any suitable shape. In this particular example, the container 10 is cuboidal having a lower wall, top wall and four sides, thereby defining a cuboidal cavity for housing a cuboidal bed of build material. In other examples, the container 10 may have an open top end without a top wall, as will be described in further detail below. In these or other examples, the container 10 may have an open lower end without a lower wall, as will be described in further detail below. In some examples a container may form part of a build unit of an additive manufacturing apparatus upon which a bed of build material is applied by additive manufacture. In other examples a container may be separate from an additive manufacturing apparatus which generates a bed of build material, and a bed of build material may be transferred to the container from the additive manufacturing apparatus or a build unit thereof.

The bed of build material as shown in FIG. 1 is provided at elevated temperature (i.e. with respect to the ambient air temperature) for cooling.

In this example, the container 10 is provided on a vibration platform 16 which is coupled to a vibration device 18 to cause vibration of the vibration platform 16 and the container 10. The vibration device 18 may be a rotary vibration motor which is to rotate an unbalanced mass to vibrate the vibration platform 16 and the container 10. However, in other examples any suitable vibration device may be used to impart vibrations to the container.

The example bed of build material as shown in FIG. 1 is provided at elevated temperature. For example, the bed of build material may be at residual elevated temperature from an additive manufacturing process which uses heat to fuse build material, or may be at residual elevated temperature owing to a heat treatment process such as tempering of the fused objects. The term “residual” is used to indicate that the elevated temperature may be as a result of previous heating rather than active heating or maintenance of elevated temperature.

By way of example only, the bed of build material as provided for cooling has a hot region of elevated temperature which may be towards a core (i.e. a central region) of the bed of build material corresponding to the location of a fused object. The hot region may be a region of local maximum temperature in the bed. Although FIG. 1 shows a single fused object by way of example, any number of fused objects may be generated in the bed. In this example there is a thermal gradient around the hot region to cooler regions of the bed, as schematically illustrated in FIG. 1 by contours 20 of constant temperature (or isotherms) about the hot region indicating a gradient of reducing temperature away from the hot region (i.e. away from the core of the bed, in this example). In other words, the hot region is hot relative to other parts of the bed. Although the contours are depicted as circular in the schematic cross-sectional illustration of FIG. 1, the contours can be of any shape depending on the shape of the hot region, a thermal distribution in the bed (which may be influenced by the location of other fused objects, for example) and the thermal gradient away from the hot region. In this illustrative example, there are three contours corresponding to temperatures of 120° C. at the innermost contour, 100° C. at the middle contour, and 80° C. at the outer contour. The temperature may be lowest towards the periphery of the bed of build material, adjacent a wall of the container. For example, the bed of build material may be provided on the vibration platform 16 for cooling following additive manufacture so that prior to vibration it has a maximum temperature in the hot region in excess of 120° C. (for example at least 150° C.) and a minimum temperature less than 80° C. (for example less than 60° C.).

The container 10 may be vibrated by operation of the vibration device 18 to vibrate the vibration platform 16 and the container. In this example, the vibration is to fluidize the unfused build material so as to cause convection of the unfused build material, thereby reducing the temperature at the hot region owing to distribution of heat from the hot region to other regions of the bed. In some examples a large portion or the entirety of the bed may be above ambient temperature. In such examples, there may be a hot region which is relatively hotter than cooler regions (e.g. towards the periphery of the bed after a period of heat dissipation through the walls) such that distribution of heat by convection causes the hot region to be cooled.

The applicant has found that objects of fused build material may be damaged if they are cooled too rapidly, for example by unpacking from unfused build material before cooling to a safe temperature, which may be referred to as an unpacking threshold. To avoid extracting unfused build material at an excessive rate which may expose uncooled fused objects to rapid cooling, the flow rate of such cooling flows may be limited. By distributing the heat by convection in the fluidized bed, a rate of cooling of a hot region may be increased relative to heat dissipation by conduction alone, without removing build material to expose fused objects before they are cooled.

Fluidization of the unfused build material is such that it behaves like a fluid (such as a liquid) which may therefore flow to establish a convection current in response to temperature variation in the bed. Fluidization is therefore different from vibration to merely agitate particulate material, for example to reduce agglomeration or promote sifting or discharge of build material through an opening. The convection distributes heat from the hot region through the bed.

In some examples there may be heat transfer from the build material to the container walls or to a cooling flow through the container, for dissipation or transport externally to the container, in addition to vibration. In this example, there is heat transfer at the periphery of the bed to the container walls, where heat is transferred to the exterior via through the container walls. This heat transfer may therefore reduce the net heat within the bed, alongside the redistribution of heat by virtue of the convection current. FIG. 1 shows example convection currents at arrows 22 and heat transfer to the ambient air through the wall at arrows 24.

In some examples, a filled container may be provided so that the bed has an even temperature distribution, such that substantially the whole bed may be considered a hot region. In such examples, heat transfer from the build material to the container walls or a cooling flow through the container may result in a thermal gradient so that a convection current may be established to distribute heat in the bed.

FIG. 2 shows the container 10 after a period of vibration to cool the hot region (which may be referred to as vibration cooling or vibration-enhanced cooling) as described above. FIG. 2 shows a single temperature contour 20 corresponding to a temperature of 60° C., representing that in this example the maximum temperature at the hot region has reduced to below 80° C., and the temperature towards the periphery of the bed is lower—in this case less than 60° C., for example 40° C.

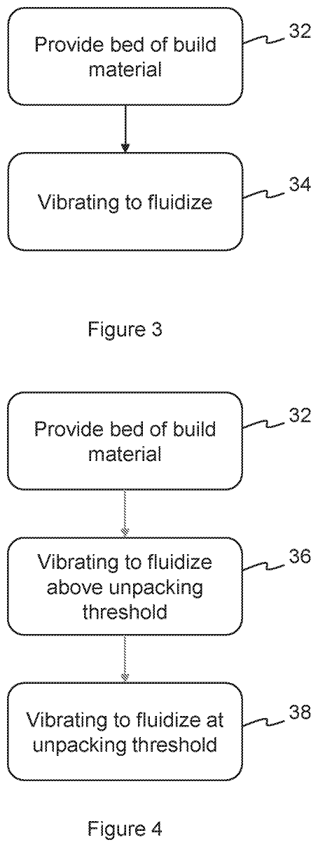

FIG. 3 is a flowchart of an example method of cooling a bed of build material generated by additive manufacture. In block 32, a bed of build material in a container is provided, the bed having a hot region relative to ambient temperature. For example, the bed of build material may be as described above with respect to the example of FIGS. 1 and 2. The hot region may correspond to the location of a fused object, or may correspond to a core region of the bed, for example. In block 34, the container is vibrated to fluidize unfused build material in the container, so as to cause convection of the unfused build material to cool the hot region as described above.

FIG. 4 is a flowchart of a further example method of cooling a bed of build material generated by additive manufacture. In block 32, a bed of build material in a container is provided as described above, the bed having a hot region relative to ambient temperature. For example, as provided, the hot region may have a temperature above an unpacking threshold temperature. The unpacking threshold may correspond to a maximum temperature at which a fused object may be unpacked from the bed without suffering adverse effects owing to rapid cooling upon exposure to ambient air, such as warpage, dimensional deformation and inaccuracy. Objects of relatively higher thickness may shatter or explode if cooled too rapidly.

The unpacking threshold may be different for different build materials. For example, when the build material is a polymer having a transition temperature (i.e. a glass transition temperature), the unpacking threshold may be related to the transition temperature. A suitable build material may be PA12 build material commercially known as V1R10A “HP PA12” and available from HP Inc., which may have a transition temperature of approximately 50° C. In some examples, the unpacking threshold may be the transition temperature. In some examples, as provided the hot region may have a temperature above an unpacking threshold temperature, for example at least 20° C. above, at least 40° C. above, or at least 60° C. above an unpacking threshold temperature when vibration commences.

In this example, the container is vibrated in a cooling phase of the method, for example a phase in which the bed of build material is undergoing substantial cooling. In block 36, the container is vibrated when the hot region is above an unpacking threshold, for example at least 20° C. above, at least 40° C. above, or at least 60° C. above the unpacking threshold. Vibration may continue to promote cooling, for example continuously or intermittently. In block 38, the container is vibrated when the hot region is at or below the unpacking threshold. Vibration therefore occurs at multiple points throughout a cooling phase of the method in which substantial cooling of the build material is occurring. In some examples, vibration may occur only when the hot region is above the unpacking threshold, and other forms of cooling may be relied upon in later periods of the cooling phase to further reduce the temperature of the hot region (for example, by drawing a cooling flow through the bed, or by natural cooling without vibration or a cooling flow).

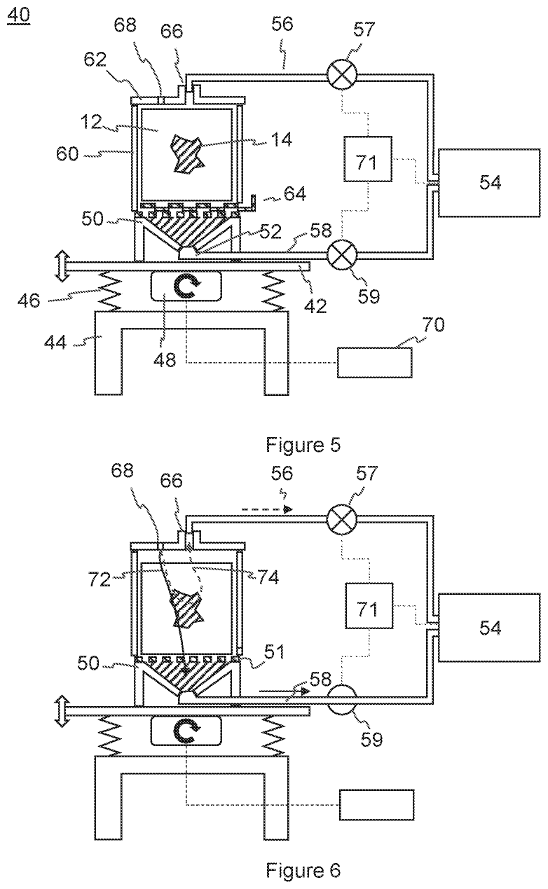

FIG. 5 shows a second example cooling apparatus 40 and a container 60 of build material. The container 60 is cuboidal and in this example comprises a removable top wall 62, side walls and a lower wall 64. In this particular example, the top wall 62 comprises an upper discharge port 66 for discharging a flow through the container. For example, the upper discharge port 64 may discharge build material entrained in the flow. In this example the top wall 62 further comprises a vent 68 for permitting a flow to enter the container 60 from ambient air or another source. The vent may be provided with a valve, such as a self closing valve or one-way valve which permits entry of a flow but prevents discharge of a flow or fluidized build material. In other examples, a discharge port or a vent may be provided at other locations of a container, for example on a side wall.

In this particular example the lower wall 64 of the container comprises a two-part structure of overlapping walls with apertures that can be selectively moved relative one another to open and close the apertures for passage of build material and/or a flow of air.

In the present disclosure, the lower wall 64 may be referred to as a guillotine. The term guillotine refers to the function of the lower wall 64 to be slid underneath or through a bed of build material generated in an additive manufacturing apparatus (e.g. a 3D printer). In some examples, a bed of build material generated in an additive manufacturing apparatus may be generated on a platform of the additive manufacturing apparatus, or on a platform of a removable module of the apparatus (e.g. a removable trolley installable in the apparatus for generation of a bed thereon). A container such as the example container shown in FIG. 5 may be provided to house the bed by placing the container without the guillotine over the top of the bed of build material, and sliding the guillotine underneath the bed of build material to enclose it. The guillotine may be secured to the side walls of the container, and the container removed from the apparatus for transfer to a material handling station, such as a cooling station.

The example container 60 of FIG. 5 is filled with a bed of build material generated by additive manufacture. In this particular example, the bed of build material comprises unfused build material 12 which surrounds a generated object of fused build material 14 as described above with respect to FIG. 1.

The cooling apparatus 40 comprises a vibration platform 42 which is to receive a container such as the container 60 described above. The guillotine 64 of the container 60 may be removed after the container 60 is received on the vibration platform 42. In this example, the vibration platform 42 is mounted in suspension over a support 44 by a suspension arrangement 46. The suspension arrangement may comprise springs or any other suitable resilient device which permits vibrating movement of the platform 42 relative the support 44.

A vibration device 48 is coupled to the vibration platform 42 to cause the vibration platform to vibrate to fluidize unfused build material in the container 60. In this example, the vibration device 48 is a rotary vibration motor which is to rotate an unbalanced mass about a rotational axis to generate vibrations in the vibration platform 42 and the container 60. A vibration device 48 may be selected based on the mass of the vibration platform 42 and the container 60. For example, for a vibration platform and a container 60 having a mass of approximately 60 kg, a rotary vibration motor having an unbalanced mass of approximately 6 kg may be selected.

The vibration device may be to cause the container to vibrate on the vibration platform at an acceleration of at least 5 m/s². In this example, the apparatus comprises a controller 70 to control operation of the vibration device. In this particular example, the controller is to operate the vibration device 48 to cause vibration of the container and build material at an acceleration of approximately 9.8 m/s² (approximately 1 g). In other examples, the controller may be to operate the vibration device 48 to cause vibrations at other accelerations, for example accelerates in the range 0.5 g (approximately 5 m/s²) to 3 g (approximately 30 m/s²). Without wishing to be bound by theory, it is thought that acceleration of build material at approximately 1 g causes fluidization as it enables particulates to enter into suspension counteracting gravity. In this example, the vibration device is to cause such acceleration along a vertical direction in the stated range. The applicant has found that vibration along a vertical direction promotes fluidization of build material to permit establishment of a convection current. The applicant has found that higher accelerations promotes fluidization, but may consume commensurately higher power. Accordingly, vibration in a moderate range of up to 30 m/s² may be selected to achieve fluidization but moderate energy consumption. The applicant has found that acceleration of the container in the lateral plane (rather than vertical acceleration) may also cause vibration of particles in the vertical plane. For example, a high absolute acceleration in the lateral plane may cause a lower absolute vertical acceleration of the unfused build material. Lateral or vertical acceleration may be used to fluidize the unfused build material.

The vibration device may be to cause the the vibration platform 42 and the filled container 60 to vibrate at an amplitude of between 0.1 mm and 50 mm, for example between 1 mm and 5 mm, or approximately 2 mm. The controller may operate to cause the vibration device to cause vibrations within this amplitude range at an acceleration within any of the above-described acceleration ranges.

The vibration device may be to cause the vibration platform 42 and the filled container 60 to vibrate at a frequency of between 20 Hz and 100 Hz, and the controller 70 may be to operate the vibration device at any frequency in this range. In some examples, the controller may operate the vibration device to vary the frequency within the range of 20 Hz to 100 Hz, for example by gradual variation between 20 Hz and 100 Hz, or between 30 Hz and 70 Hz, or between 40 Hz and 60 Hz, or by intermittent operation at two or more different frequencies such as 20 Hz, 30 Hz, 40 Hz, 50 Hz, 60 Hz, 70 Hz, 80 Hz, 90 Hz and 100 Hz. Without wishing to be bound by theory, the applicant has found that a frequency at which fluidization begins to occur at low energy (which may be referred to as a fluidization frequency) for a particular bed in a first fluidization period may on occasion not result in fluidization of the same bed in a second fluidization period. It is thought that the fluidization frequency of a bed may therefore vary. Accordingly, the container may be vibrated at multiple different frequencies over different respective fluidization periods, or the frequency may vary continuously or in a step-wise manner. The controller may operate to cause the vibration device to cause vibrations at any of the above frequencies at any of the amplitudes and accelerations described above.

The applicant has previously considered providing vibration devices on a container to reduce agglomeration or promote sifting of build material through an opening for collection. However, such previously considered devices do not cause fluidization of build material such that a convection flow may be established. Such devices may provide relatively weak vibration in a lateral plane only for the purpose of promoting relative movement between loose particles.

In some examples, a container may be received (i.e. supported) directly on the vibration platform. In this particular example, the container 60 is received on the vibration platform indirectly by mounting it on an extraction guide 50 which is coupled to the vibration platform and is to guide build material discharged from the lower end of the container (i.e. corresponding to the location of the guillotine 64 once removed, as will be described below) to a lower discharge port 52. The extraction guide 50 can take any suitable form, and in this example is generally conical tapering from the rectangular lower end of the container to the lower discharge port 52 to guide discharged build material in use, as will be described below.

In this example, the container 60 is received on an extraction plate 51 of the extraction guide 50. The extraction plate 51 is to support the container 60 and provide an opening for discharging build material from the container 60. In this particular example, the extraction plate 51 is provided with a plurality of openings to discharge build material from the container 60 to the lower discharge port 52. In other examples, an extraction plate 51 may be integral with or coupled to a vibration platform with or without an extraction guide.

The cooling apparatus further comprises flow equipment to cause a forced flow through the container 60. The term forced is intended to mean that the flow is driven by mechanical action rather than owing to natural convection. For example, the flow may be driven by a source of compressed air or an upstream or downstream pump or fan, or drawn by a vacuum source. In this example, the flow equipment comprises a vacuum source and a discharge path for drawing a flow through the container 60 under action of the vacuum source.

The discharge path can be coupled to a container at any location to draw a flow therethrough along a respective direction. In this particular example, there is a first discharge path 56 and a second discharge path 58 for coupling to first and second discharge ports 66, 52 respectively to draw a flow through the container 60. The paths may comprise pipework, flexible hoses, ducts or take any suitable form for conveying a flow of air. In this example, the first discharge port 66 is the upper discharge port provided in the top wall 62 as described above, whereas the second discharge port 52 is the lower discharge port 52 provided at the base of the extraction guide 50. In other examples, the second discharge port 52 may be integral with the container 60, or the first first discharge port 66 may be provided on a guide that interfaces with the container.

In this example, the first and second discharge paths 56, 58 are provided with valves 57, 59 for selectively closing the respective path to permit or prevent a flow being drawn along the respective path. The cooling apparatus may further comprise a controller 71 to alternately cause a cooling flow along the first discharge path 56 and the second discharge path respectively, for example by selectively opening and closing the respective valves 57, 59.

In examples, the flow equipment may be for causing a cooling flow to flow through the container for cooling the bed of build material, or for causing an extraction flow to flow through the container for entraining build material and discharging it from the container. An extraction flow may also be a cooling flow if it is cooler than the build material. Whether a flow has a cooling effect or not may therefore be dependent on the relative temperature of the build material and the ambient conditions. Therefore, in the present disclosure an apparatus may be properly described as being to cause a forced cooling flow through the container irrespective of whether the flow is cooling in use.

In the example cooling apparatus 40 of FIG. 5, the flow equipment is to cause a cooling flow through the container 60 and along the respective passageways. This may enhance the cooling provided by vibration to cause convection in the bed, together with any conduction at the container walls. In this particular example, the flow equipment is to cause unfused build material to be removed from the container 60 by entraining build material in the cooling flow (which is also an extraction flow), which may flow through the bed.

FIG. 5 shows the cooling apparatus 40 with the container 60 in a closed configuration in which a flow through the container and through any of the discharge paths 56, 58 is prevented. The cooling apparatus may be operated to vibrate the container 60 in the closed configuration, which may cause a convection current to flow to distribute heat as described above to cool a hot region of the bed. In this particular example, the container 60 is placed in the closed configuration by closing the valves 57, 59 in the first and second discharge paths 56, 58.

FIG. 6 shows the cooling apparatus 40 with the container in an example closed top configuration in which flow and discharge of build material is prevented through the top wall 62 of the container and along the first discharge path, whereas flow is permitted through the container along another route. The cooling apparatus 40 may be operated to vibrate the container in the closed top configuration.

In this particular example, flow is prevented through the top wall 62 and along the first discharge path 56 by closure of the valve 57 in the first discharge path 56, and by causing the valve 59 in the second discharge path 58 to be open to permit flow through the extraction plate 51. As shown in FIG. 6, in this configuration the guillotine or lower wall 64 of the container 60 is removed so that the bed of build material is supported on the extraction plate 51. Removal of the guillotine 64 may reveal an opening in a side wall of the container 60 or between the container 60 and the extraction plate 51, which may be closed by a flap or other door of the container.

In the example closed top configuration a cooling flow is drawn through the vent 68, through the bed of build material along a downward direction (as indicated by solid arrow 72), through the open lower end of the container 60, through the extraction guide 50 and the lower discharge port 52 to flow along the second discharge path 58 to the vacuum source 54.

The example cooling apparatus 40 also has a closed base configuration in which flow and discharge of build material through the lower end of the container is prevented. Flow may be permitted through the container along another route in the closed base configuration. In this particular example, flow and discharge of build material through the lower end of the container is prevented by closing the valve 59 in the second discharge path 58, whereas the valve 57 in the first discharge path 56 is open to permit a flow along the first discharge path 56. A cooling flow is drawn into the container through the vent 68 in the top wall 62 of the container and through the bed of build material along a downward and upwardly returning path to be discharged through the first discharge port 66 and along the first discharge path to the vacuum source 54. The applicant has found that the cooling flow may be drawn into the bed despite entering the container and being discharged from the container through ports in the same wall (i.e. the top wall 62). However, in other examples a cooling flow may flow over an upper surface of the bed rather than permeate through the bed.

A controller 70 of the cooling apparatus 40 may be to control the vibration device 48 to vibrate periodically or continuously during a cooling phase of at least 2 hours. The duration of the cooling phase may depend on the build material and the size of the bed. The controller may be to control the vibration device 48 to stop vibrating at the end of the cooling phase, for example after a predetermined period of time or when a predetermined condition is met, such as a temperature from a temperature sensor in or on the container, or a temperature sensor to monitor a temperature of a flow from the container 60. A controller for the vibration device may be the same as or distinct from a controller for the cooling equipment.

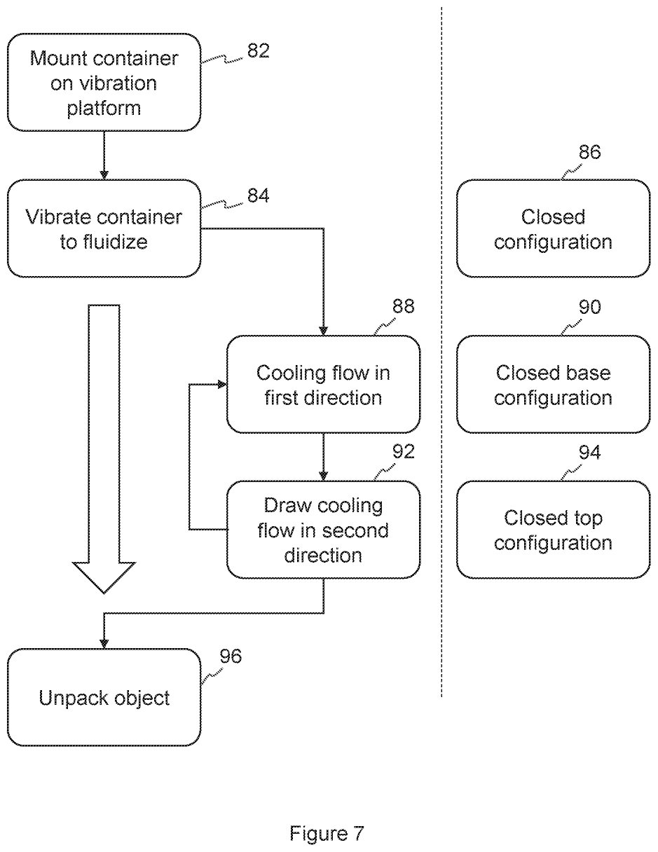

FIG. 7 is a flow chart of a method of cooling a bed of build material generated by additive manufacture. By way of example only, the method will be described with respect to the example cooling apparatus 40 and container 60 described above with respect to FIGS. 5 and 6.

In block 82, a container is provided containing a bed of build material, the bed having a hot region relative to ambient temperature. In this particular example, the container 60 is mounted on the vibration platform 42 indirectly by being mounted on the extraction guide 50 which is coupled to the vibration platform 42, and the vibration platform 42 is distinct from the container 60. If the container is provided with a guillotine lower wall 64, the guillotine may be removed as described above.

In block 84, the container is vibrated to fluidise unfused build material. In this particular example the vibrations are so as to cause convection of the unfused build material to cool the hot region, which corresponds to an object of fused build material. Vibration may commence a cooling phase of the method to cool the hot region of the bed, for example to permit unpacking. The controller 71 may control the vibration of the container.

The right hand column of FIG. 7 depicts the configuration of the cooling apparatus 40 and the container 60 whilst the corresponding block at the same vertical position in the flow chart is being executed.

Vibration of the container to fluidize the build material commences at block 84 in the closed configuration (block 86) such that flow through the container 60 is prevented for at least a corresponding phase of vibration.

The vibration may cause acceleration of the container of at least 9.8 m/s², for example approximately 9.8 m/s². The vibration may be along a vertical axis. The vibration may be at an amplitude in a range between 0.1 mm and 50 mm, for example between 1 mm and 5 mm, for example 2 mm. The vibration may be at a frequency of between 20 Hz and 100 Hz, and may vary during a phase of vibration, for example continuously or discontinuously. The controller 71 may operate to control the vibration within any or each of the acceleration, amplitude and frequency ranges.

As depicted by the arrow depending from block 84, vibration continues during further blocks 88, 92 of the method relating to causing a cooling flow through the container. Vibration may be continuous whilst a cooling flow is caused to flow, may be intermittent, or a cooling flow may be caused to flow between periods of vibration.

The cooling apparatus 40 and container 60 are put in the closed base configuration (block 90) so that flow through the lower end of the container 60 and along the second discharge path 56 is prevented, whilst a cooling flow is permitted along another route. In this particular example, a cooling flow is permitted into the container through the vent 68 in the top wall 62 and through the container along a path to the first discharge port 66 in the top wall 62, and then along the first discharge path 56 to the vacuum source 54. The cooling flow may permeate the bed or flow over an upper surface of the bed. Build material may be entrained in the cooling flow so as to be discharged from the container. The controller 71 may open the valve 57 in the first discharge path 56 and close the valve 59 in the second discharge path 58 to place the container in the closed base configuration. The controller 71 may control the vacuum source 54 so that the flow through the bed is at a rate to entrain unfused build material, for example in a range from 10 to 40 litres per second, such as 20 litres per second.

The container is then put in the closed top configuration (block 90) so that flow through the top wall 62 of the container and along the first discharge path 58 is prevented, whilst a cooling flow is permitted along another route. In this particular example, a cooling flow is permitted down into the container through the vent 68 in the top wall 62 and through the container along the downward direction 72 through the lower end of the container and the extraction guide 50, and along the second discharge path 58 to the vacuum source 54. The vacuum source is operated to draw the cooling flow through the container 10 along the downward direction 72. Build material is entrained in the cooling flow so as to be discharged from the container. The controller 71 may open the valve 59 in the second discharge path 58 and close the valve 57 in the first discharge path 56 to place the container in the closed top configuration. The controller 71 may control the vacuum source 54 so that the flow through the bed is at a rate to entrain unfused build material.

The controller 71 may cause the cooling apparatus 40 and container 60 to alternate between the closed top and closed base configurations, for example by switching every 20 minutes during the cooling phase.

The cooling phase may be terminated by stopping vibration of the container and operating the vacuum source to stop drawing a flow through the container.

By way of example, the cooling phase may last 5 hours. The container may be vibrated throughout the cooling phase or for an initial period of the cooling phase without vibration during an end period of the cooling phase. For example, the container may be vibrated in the first 3 hours of the cooling phase and not for the final 2 hours.

In this example, build material is entrained in the cooling flow through the container and gradually discharged from the container. For example, a portion of the build material may be removed during the cooling phase, such as at least 50%, at least 75%, at least 90% or at least 95%. However, in other examples there may be no discharge of build material during the cooling phase.

In block 96 the cooling phase is terminated and the object of fused build material is unpacked from the remaining unfused build material of the bed by manipulating it to separate it from the remaining unfused build material or agitating to the remaining unfused build material to remove it from the object. The object is withdrawn from the container.

Although an example has been described in which a flow is drawn through a container so that it flows through a bed, in other examples a cooling or extraction flow may flow over the bed rather than through the bed. For example, a flow may be caused to flow through the container between ports provided in the top wall or upper portions of the side walls so that the flow passes over the bed rather than through it.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method of cooling a bed of build material generated by additive manufacture, the method comprising:
providing a container containing a bed of build material, the bed having a hot region relative to ambient temperature;
vibrating the container to fluidize unfused build material in the container so as to cause convection of the unfused build material to cool the hot region.

2. A method according to claim 1, wherein the container is mounted on a vibration platform distinct from the container for vibration, the vibration platform being coupled to a vibration device to cause vibration of the vibration platform and the container.

3. A method according to claim 1, wherein vibrating the container causes acceleration of the container of at least 9.8 m/s².

4. A method according to claim 1, wherein vibrating the container causes the container to vibrate along a vertical axis.

5. A method according to claim 1, wherein vibrating the container causes the container to vibrate at a frequency of between 20 and 100 Hz.

6. A method according to claim 1, further comprising causing a cooling flow to flow through the container.

7. A method according to claim 6, further comprising:
causing a cooling flow to flow through the bed and out of the container along a first discharge path through a first discharge port of the container, and causing a cooling flow to flow through the bed and out of the container along a second discharge path through a second discharge port of the container;
wherein flow along the second discharge path is prevented when the cooling flow is drawn along the first path; and wherein flow along the first discharge path is prevented when the cooling flow is drawn along the second discharge path.

8. A method according to claim 1, further comprising preventing flow through a lower end of the container in a closed base configuration, wherein the container is vibrated to fluidize unfused build material in the closed base configuration.

9. A method according to claim 1, further comprising preventing flow through the container in a closed configuration, wherein the container is vibrated to fluidize build material when the container is in the closed configuration.

10. A build material cooling apparatus comprising:
a vibration platform, wherein the vibration platform is to receive a filled container holding a bed of build material generated by additive manufacture;
a vibration device coupled to the vibration platform to cause the vibration platform to vibrate to fluidize unfused build material in a container received on the vibration platform;
flow equipment to cause a forced flow through a container received on the vibration platform.

11. A build material cooling apparatus according to claim 10, further comprising a controller, wherein the controller is to control the vibration device to:
cause a container to vibrate on the vibration platform at an acceleration of at least 9.81 m/s²;
cause the vibration platform and the filled container to vibrate at an amplitude of between 0.1 mm and 50 mm; and/or
cause the vibration platform and the filled container to vibrate at a frequency of between 20 Hz and 100 Hz.

12. A build material cooling apparatus according to claim 10, wherein the vibration device and vibration platform are to vibrate the container along a vertical axis.

13. A build material cooling apparatus according to claim 10, wherein the flow equipment comprises an extraction guide coupled to the vibration platform, wherein the extraction guide is to guide build material discharged from a lower wall of a container received on the vibration platform to a discharge port for extraction.

14. A build material cooling apparatus according to claim 10, wherein the flow equipment comprises:
a vacuum source;
a first discharge path for coupling to a first discharge port to draw a cooling flow through a container received on the vibration platform in a first direction; and
a second discharge path for coupling to a second discharge port to draw a cooling flow through a container received on the vibration platform in a different second direction and
a controller to alternately cause a cooling flow along the first discharge path and the second discharge respectively.

15. A method of cooling a bed of build material generated by additive manufacture, the method comprising:
providing a bed of build material in a container, the bed having an object of fused build material;
vibrating the container to fluidize unfused build material in the container in a cooling phase to promote cooling, including vibrating when the temperature of the object is greater than an unpacking threshold.
